(19) United States
(12) Patent Application Publication
(10) Pub. No.: US 2024/0263092 A1
(43) Pub. Date: Aug. 8, 2024

(54) COMBINED TORREFACTION AND PYROLYSIS WASTE PROCESSOR

(71) Applicant: Serge Borys, North Vancouver (CA)

(72) Inventor: Serge Borys, North Vancouver (CA)

(21) Appl. No.: 18/433,559

(22) Filed: Feb. 6, 2024

(30) Foreign Application Priority Data
Feb. 6, 2023 (CA) 3188638

(51) Int. Cl. C10J 3/18; B01J 6/00; C01B 3/02; C01B 32/324; C10B 53/02; C10B 57/10; C10B 57/14; C10B 57/16

(52) U.S. Cl. CPC C10J 3/18; B01J 6/008; C01B 3/02; C01B 32/324; C10B 53/02; C10B 57/10; C10B 57/14; C10B 57/16; C10J 2200/12; C10J 2300/0906; C10J 2300/0909; C10J 2300/0916; C10J 2300/1276; C10J 2300/1284

(57) ABSTRACT

A biomass waste processor combining torrefaction and pyrolysis of biomass waste products operating at fixed temperatures via electric heating elements.

### FIELD OF THE INVENTION

The present specification relates generally to a waste processor, and more particularly to a biomass waste processor combining torrefaction and pyrolysis.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

Waste processing through pyrolysis has been proposed as being both environmentally friendly and capable of producing industrially applicable byproducts. Pyrolysis (heating in the absence of air) of biomass products (i.e. wood, rubber, etc.) is capable of producing biochar (e.g. activated carbon) and syngas (Hydrogen/Carbon Monoxide mixture), both of which have useful industrial applications.

However, the output products are subject to variation in quality and usefulness depending on the quality of the pyrolysis process. Variations in the moisture content of the feedstock, temperature of the pyrolysis and type and size of the feedstock biomass all have an effect on the output products.

While there are some pyrolysis devices and methods known in the art, it would be desirable to have a pyrolysis device and method which mitigates some of the disadvantages of existing deices and methods.

Accordingly, there remains a need for improvements in the art.

### SUMMARY OF THE INVENTION

In accordance with an aspect of the invention, there is provided a waste processor, and more particularly to a biomass waste processor combining torrefaction and pyrolysis.

According to an embodiment of the invention, there is provided a biomass waste processor, comprising: a biomass feedstock storage, the biomass feedstock storage operative to store biomass feedstock at a fixed storage temperature, the fixed storage temperature in a range of 13° C. to 30° C.; a biomass feedstock dryer coupled to the biomass feedstock storage, the biomass feedstock dryer operative to increase the temperature of the biomass feedstock to a range of 200° C.-300° C.; a biomass feedstock shredder coupled to the biomass feedstock dryer, the biomass feedstock shredder operative to shred the biomass feedstock into particles sized from 2 mm to 1 cm in diameter; a first reaction chamber coupled to the biomass feedstock shredder, the first reaction chamber operative to perform torrefaction of the biomass feedstock at a fixed temperature to produce a combination of torrefied biomass and syngas, the first reaction chamber comprising electric heating elements to maintain the fixed temperature within the first reaction chamber; a second reaction chamber coupled to the first reaction chamber, the second reaction chamber operative to perform pyrolysis of the torrefied biomass at a fixed temperature to produce syngas and one of: biochar and activated carbon, the second reaction chamber comprising electric heating elements to maintain the fixed temperature within the second reaction chamber; a third reaction chamber coupled to the first reaction chamber, the third reaction chamber operative to perform pyrolysis of the torrefied biomass at a fixed temperature to produce syngas and one of: biochar and activated carbon, the third reaction chamber comprising electric heating elements to maintain the fixed temperature within the second reaction chamber; a gas extractor, the gas extractor coupled to the second reaction chamber and the third reaction chamber, the gas extractor operative to extract syngas from the second reaction chamber and the third reaction chamber during pyrolysis; and an electricity generation system, the electricity generation system operative to produce electricity for the biomass waste processor.

According to a further embodiment, the biomass feedstock dryer may comprise an auger operative to mix the biomass feedstock within the biomass feedstock dryer. According to a still further embodiment, the gas extractor may be coupled to a dust separator, the dust separator operative to separate dust particulates from the syngas to produce a fine syngas. The dust separator may be further coupled to an oil-gas separator, the oil-gas separator operative to separate bio-oil from the fine syngas to produce a clean syngas.

According to a further embodiment, the electricity generation system may comprise an electrical generator operative to produce electricity for the biomass waste processor, the electrical generator fueled by the clean syngas. The electricity generation system may further comprise a solar panel array, the solar panel array operative to generate electricity and supply the generated electricity to the biomass waste processor. The electricity generation system may further comprise one or more batteries, the batteries operative to store excess electricity from the electricity generation system.

According to a still further embodiment, the first reaction chamber, the second reaction chamber and the third reaction chamber may each be formed with an interior lining of fireclay concrete and an exterior steel casing. wherein the fixed temperature for the first reaction chamber is at least 300° C. and the fixed temperature for the second reaction chamber and the third reaction chamber is at least 1000° C.

The biomass waste processor may further comprise a boiler coupled to the oil-gas separator, the boiler operative to generate superheated steam, and supply the superheated steam to the oil-gas separator, the boiler further comprising electric heating elements.

The biomass waste processor may still further comprise a biochar packaging system coupled to the second reaction chamber and the third reaction chamber, the biochar packaging system operative to inject carbon dioxide into the biochar to produce a stabilized biochar.

The biomass waste processor may yet further comprise a heat exchanger coupled to the biomass feedstock dryer, the heat exchanger operative to exchange waste heat from an exhaust of the biomass waste processor with the biomass feedstock dryer.

According to another embodiment, there is provided a method for biomass waste processing, comprising: storing a biomass feedstock at a controlled temperature range of 13° C. to 30° C.; drying the stored biomass feedstock to a temperature range of 200° C.-300° C. to produce a dried biomass feedstock; shredding the dried biomass feedstock to produce a shredded biomass feedstock; torrefying the shredded biomass feedstock in a first reaction chamber at a fixed temperature maintained by electric heating elements to produce a torrefied biomass; pyrolyzing the torrefied biomass in a second reaction chamber and a third reaction chamber at a fixed temperature maintained by electric heating elements to produce syngas and one of: biochar and activated carbon; extracting the syngas from the second reaction chamber and the third reaction chamber during pyrolysis; and generating electricity for the biomass waste processor via an electricity generation system.

According to a further embodiment, the method may further comprise cleaning the extracted syngas by passing the extracted syngas through a dust separator and then through an oil/gas separator to produce a clean syngas.

According to a further embodiment, the electricity generation may be performed by a combination of solar panels and fuel cells. The method may further comprise storing excess electricity from the electricity generation step in one or more batteries.

According to a further embodiment, the method may further comprise injecting superheated steam into the reaction chamber during the pyrolyzing step. The wherein the fixed temperature for pyrolyzing may be at least 1000° C.

According to a further embodiment, the method may further comprise injecting carbon dioxide into the biochar prior to packaging the biochar for storage.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a block diagram of a biomass waste processor according to an embodiment; and

FIG. 2 is a flowchart of the biomass waste processing method according to an embodiment.

Like reference numerals indicated like or corresponding elements in the drawings.

### DETAILED DESCRIPTION OF THE EMBODIMENTS

The present invention relates to a waste processor, and more particularly to a biomass waste processor combining torrefaction and pyrolysis.

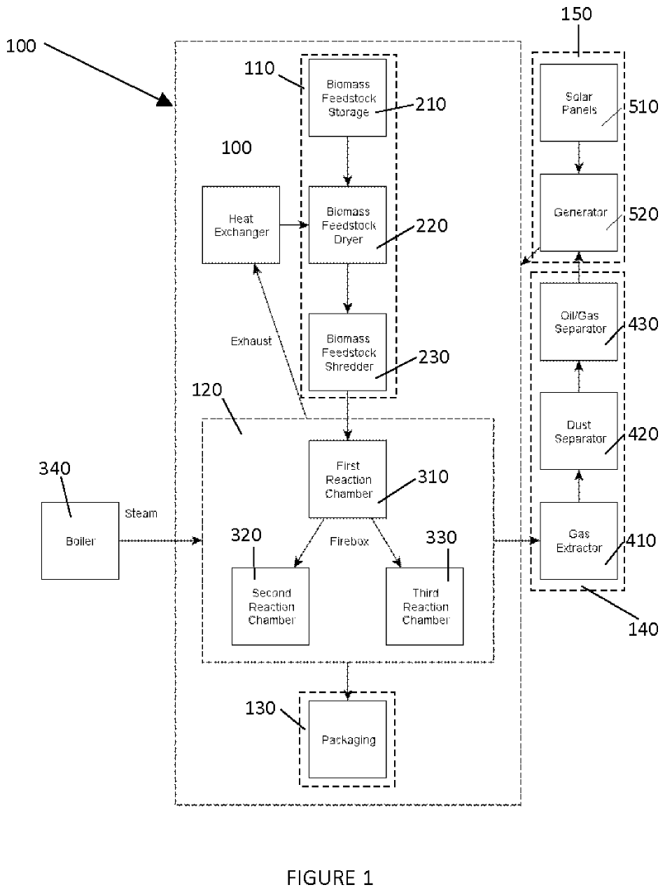

According to an embodiment as shown in FIG. 1, a biomass waste processor 100 is comprised of several components. In an embodiment, the biomass waste processor 100 includes a biomass feedstock handler 110, a biomass reaction chamber 120, an output unit 130, a gas processor 140 and an electrical power source 150.

The biomass feedstock handler 110 is operative to store, prepare and transfer the biomass feedstock into the biomass chamber 120 for treatment as discussed below. In an embodiment, the biomass feedstock handler includes a biomass feedstock storage 210, where the biomass feedstock is stored prior to treatment. The biomass feedstock storage comprises a container (e.g. a silo) which is held at a constant storage temperature using electric heating elements. The container may further be winterized (insulated) and weatherproofed when in colder and harsher environment. The preferred storage temperate for the majority of biomass feedstocks is between 13° C. and 30° C.

The biomass feedstock is then transferred by conveyor or auger or similar means from the biomass feedstock storage 210 into a biomass feedstock dryer 220. The biomass feedstock dryer 220 operates at a constant fixed temperature using electric heating elements to dry (remove moisture from) the biomass feedstock prior to processing. As with the biomass feedstock storage 210, the biomass feedstock dryer 220 may be winterized (insulated) and weatherproofed according to the environment. The preferred temperature for the biomass feedstock dryer 220 is between 200° C. and 300° C.

The dried biomass feedstock is then passed through a biomass feedstock shredder 230. The biomass feedstock shredder 230 processes the dried biomass feedstock to produce a shredded biomass feedstock of generally uniform consistency and size. The preferred size for the shredded biomass feedstock in the range of 2 mm to 1 cm in diameter. In some embodiments, the biomass feedstock shredder may be adjustable to accommodate different types of biomass feedstock and to produce different sizes of shredded biomass feedstock.

The dried and shredded biomass feedstock is then moved (again by conveyor or auger) into the biomass reaction chamber 120 for processing. In an embodiment, the biomass reaction chamber 120 includes a first reaction chamber 310, a second reaction chamber 320 and a third reaction chamber 330. The biomass reaction chamber 120 comprises a sealed and insulated firebox. In an embodiment, the firebox is formed with an interior lining of fireclay concrete and an exterior steel case.

The first reaction chamber 310 operates at a constant fixed temperature suitable for torrefaction of the biomass feedstock. In most embodiments, the fixed temperature of the first reaction chamber 310 is 300C. The torrefaction process in the first reaction chamber 310 produces a torrefied biomass product (e.g. torrefied wood products) and volatile gases which may be extracted and treated/stored for other uses. The torrefied biomass product may be extracted at this step of the process for alternate uses.

Potential issues with biomass feedstocks may include: non-homogenous combustion characteristics; low bulk density of the feedstock; high affinity for water retention; low energy content; and perishable nature. By drying and torrefying the biomass feedstock, the torrefied biomass product has greater homogeneity and lower moisture content, and an overall higher energy content, than the starting biomass feedstock. The torrefied biomass product may also be suitable for other industrial purposes, and is thus a viable commercial product if extracted from the first reaction chamber and suitably packaged.

In an embodiment, the torrefied biomass product is transferred to the second reaction chamber 320 and third reaction chamber 330 for further processing. The second reaction chamber 320 and third reaction chamber 330 operate at a constant fixed temperature suitable for pyrolysis of the torrefied biomass product. The fixed temperature applied is dependent on the desired pyrolysis output product. In an embodiment, the fixed temperature is in the range of 500C-600C, which produces a biochar output product along with syngas. In another embodiment, the fixed temperature is in the range of 900C-1000C, which produces an activated carbon output product along with syngas.

Superheated steam from a boiler 340 may be injected into the second reaction chamber 320 and the third reaction chamber 330 during the pyrolysis process. The steam is superheated to prevent the steam from condensing into water during the pyrolysis process or when travelling through the system.

The solid pyrolysis output products are then extracted and processed for further use and the output unit 130. For the solid biochar and/or activated carbon products, there is a risk of spontaneous combustion either during storage or transportation. Accordingly, the solid products are packaged with injected carbon dioxide to reduce this risk. Additionally, as part of the output unit 130, the hot exhaust from the biomass reaction chamber 120 may be directed through a heat exchanger to heat or provide a boost to heating in the biomass feedstock dryer 220.

The syngas output product, either from the first reaction chamber 310, or the second and third reaction chambers 320, 330, is extracted from the biomass reaction chamber 120 into a gas processor 140 via a gas extractor 410. The extracted syngas may be subject to further treatment to produce desired output products. In an embodiment, the syngas may be passed through a dust separator 420 to remove large dust particulates and output a fine syngas. The fine syngas may then further be passed through an oil/gas separator 430 which subjects the fine syngas to a jet stream of high-temperature (near boiling) water droplets. The jet stream separates out bio-oil (including fine dust particles) from the fine syngas to produce a clean syngas with a substantial amount of impurities removed.

The clean syngas may be burned directly, with a cleaner burn profile that standard syngas from pyrolysis. The clean syngas may also be treated via industrial processes into separate gas components (CO₂, CO, hydrogen, methane) for industrial purposes.

As discussed above, the biomass waste processor 100 operates using electric heating elements. Accordingly, an electric power source 150 is required to provide the electricity necessary for operation. In an embodiment, the electric power source 150 is located on the operational site of the biomass waste processor 100 and operates using renewable energy sources to the best extent possible.

In an embodiment, one renewable source is a solar array 510. The solar array may comprise a stand-alone array of solar panels, as well as solar panels distributed over the buildings and structures forming the biomass waste processor 100. The overall amount of electricity provided thus depends on the overall size of the site as well as the environmental conditions.

Additional electricity generation capacity may be provided through the use of a generator 520 powered by fuel cells operating using the extracted gases from the clean syngas produced by the biomass waste processor 100. To further enhance the overall on-site support, the water produced of fuel cell operations may be fed back to supply the operation of the biomass was processor 100.

Further, one or more batteries may be provided to store excess electricity generated by the electric power source 150. The stored electricity may be used to provide a backup source for the biomass waste processor 100, and/or may be fed back into the local power grid for income or credits.

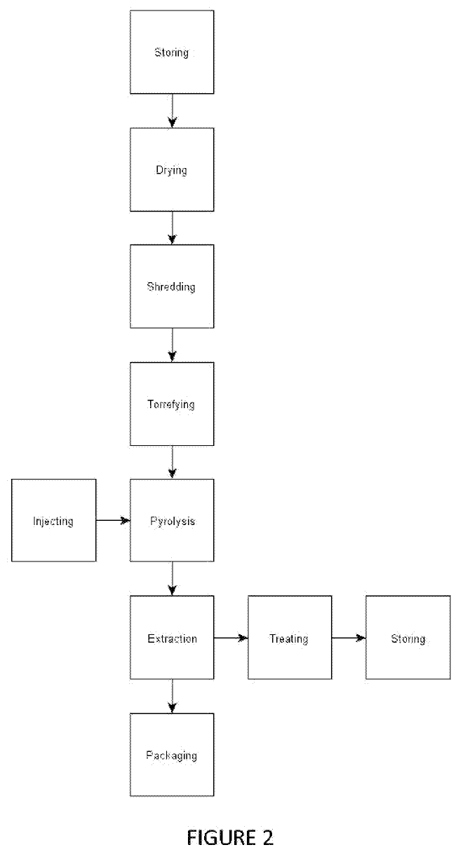

Operationally, as shown in the embodiment in FIG. 2, the method of operating the biomass waste process 100 begins with receiving an amount of biomass feedstock for processing. The biomass feedstock may be wood (e.g. sawdust), rubber (e.g. used tires), or other biowaste products. The biomass feedstock is then stored in a silo or similar container at a fixed temperature until ready for processing.

To begin processing, the stored biomass feedstock is first dried to remove moisture and to raise the temperature of the biomass feedstock prior to further processing. The dried biomass feedstock may then be shredded to increase uniformity and reduce average particle size.

The dried and shredded biomass feedstock if then transferred to the first reaction chamber which performs torrefaction of the biomass feedstock at an electrically fixed temperature of 300C to produce a torrefied biomass product and a torrefied volatile (gas) product. The torrefied volatile product is extracted, and the torrefied biomass product by either be extracted as well or transferred to the second and third reaction chambers for further processing.

Where further processed, the torrefied biomass product is pyrolyzed at an electrically fixed temperature in the second and third reaction chambers to produce a pyrolyzed biomass product and syngas. The type of pyrolyzed biomass product depends on the fixed temperature. A fixed temperature in the 500C-600C range produces biochar as a solid output product. A fixed temperature in the 900C-1000C range produces activated carbon as a solid output product. Superheated steam may be injected from a boiler to assist in the pyrolysis process. In any case, the solid pyrolyzed biomass product is transferred for packing and storage or transportation.

The syngas is extracted and further treated prior to storage or use. In an embodiment, the syngas is first passed through a dust separator to remove large dust particulates and produce a fine syngas. The fine syngas is then passed through an oil/gas separator to further remove finer dust particulates, as well as bio-oils, to produce a clean syngas.

The clean syngas may then be processed into different gas and oil components and stored for future use and/or transportation. In an embodiment, hydrogen (and/or methanol) extracted from the clean syngas may be used in fuel cells on site to generate electricity for the biomass waste processor.

Accordingly, the overall method of processing biomass through the biomass waste processor 100 may be considered as a closed-loop type of method, whereby output products (e.g. syngas) are used to generate input products (e.g. electricity), acknowledging the input of the biomass feedstock and the output of the solid pyrolyzed biomass products.

It should also be noted that the steps described in the method of use can be carried out in many different orders according to user preference. The use of “step of” should not be interpreted as “step for”, in the claims herein and is not intended to invoke any interpretation provisions. It should also be noted that, under appropriate circumstances, considering such issues as design preference, user preferences, marketing preferences, cost, structural requirements, available materials, technological advances, etc., other methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A biomass waste processor, comprising:
a biomass feedstock storage, the biomass feedstock storage operative to store biomass feedstock at a fixed storage temperature, the fixed storage temperature in a range of 13° C. to 30° C.;
a biomass feedstock dryer coupled to the biomass feedstock storage, the biomass feedstock dryer operative to increase the temperature of the biomass feedstock to a range of 200° C.-300° C.;
a biomass feedstock shredder coupled to the biomass feedstock dryer, the biomass feedstock shredder operative to shred the biomass feedstock into particles sized from 2 mm to 1 cm in diameter;
a first reaction chamber coupled to the biomass feedstock shredder, the first reaction chamber operative to perform torrefaction of the biomass feedstock at a fixed temperature to produce a combination of torrefied biomass and syngas, the first reaction chamber comprising electric heating elements to maintain the fixed temperature within the first reaction chamber;
a second reaction chamber coupled to the first reaction chamber, the second reaction chamber operative to perform pyrolysis of the torrefied biomass at a fixed temperature to produce syngas and one of: biochar and activated carbon, the second reaction chamber comprising electric heating elements to maintain the fixed temperature within the second reaction chamber;
a third reaction chamber coupled to the first reaction chamber, the third reaction chamber operative to perform pyrolysis of the torrefied biomass at a fixed temperature to produce syngas and one of: biochar and activated carbon, the third reaction chamber comprising electric heating elements to maintain the fixed temperature within the second reaction chamber;
a gas extractor, the gas extractor coupled to the second reaction chamber and the third reaction chamber, the gas extractor operative to extract syngas from the second reaction chamber and the third reaction chamber during pyrolysis; and
an electricity generation system, the electricity generation system operative to produce electricity for the biomass waste processor.

2. The biomass waste processor of claim 1, wherein the biomass feedstock dryer comprises an auger operative to mix the biomass feedstock within the biomass feedstock dryer.

3. The biomass waste processor of claim 1, further comprising a dust separator coupled to the gas extractor, the dust separator operative to separate dust particulates from the syngas to produce a fine syngas.

4. The biomass waste processor of claim 3, further comprising an oil-gas separator coupled to the dust separator, the oil-gas separator operative to separate bio-oil from the fine syngas to produce a clean syngas.

5. The biomass waste processor of claim 4, wherein the electricity generation system comprises an electrical generator operative to produce electricity for the biomass waste processor, the electrical generator fueled by the clean syngas.

6. The biomass waste processor of claim 3, further comprising a boiler coupled to the oil-gas separator, the boiler operative to generate superheated steam, and supply the superheated steam to the oil-gas separator, the boiler further comprising electric heating elements.

7. The biomass waste processor of claim 1, further comprising a biochar packaging system coupled to the second reaction chamber and the third reaction chamber, the biochar packaging system operative to inject carbon dioxide into the biochar to produce a stabilized biochar.

8. The biomass waste processor of claim 1, wherein the electricity generation system comprises a solar panel array, the solar panel array operative to generate electricity and supply the generated electricity to the biomass waste processor.

9. The biomass waste processor of claim 1, further comprising one or more batteries, the batteries operative to store excess electricity from the electricity generation system.

10. The biomass waste processor of claim 1, wherein the first reaction chamber, the second reaction chamber and the third reaction chamber are each formed with an interior lining of fireclay concrete and an exterior steel casing.

11. The biomass waste processor of claim 1, further comprising a heat exchanger coupled to the biomass feedstock dryer, the heat exchanger operative to exchange waste heat from an exhaust of the biomass waste processor with the biomass feedstock dryer.

12. The biomass waste processor of claim 1, wherein the fixed temperature for the first reaction chamber is at least 300° C.

13. The biomass waste processor of claim 1, wherein the fixed temperature for the second reaction chamber and the third reaction chamber is at least 1000° C.

14. A method for biomass waste processing, comprising:
storing a biomass feedstock at a controlled temperature range of 13° C. to 30° C.;
drying the stored biomass feedstock to a temperature range of 200° C.-300° C. to produce a dried biomass feedstock;
shredding the dried biomass feedstock to produce a shredded biomass feedstock;
torrefying the shredded biomass feedstock in a first reaction chamber at a fixed temperature maintained by electric heating elements to produce a torrefied biomass;
pyrolyzing the torrefied biomass in a second reaction chamber and a third reaction chamber at a fixed temperature maintained by electric heating elements to produce syngas and one of: biochar and activated carbon;
extracting the syngas from the second reaction chamber and the third reaction chamber during pyrolysis; and
generating electricity for the biomass waste processor via an electricity generation system.

15. The method of claim 14, further comprising cleaning the extracted syngas by passing the extracted syngas through a dust separator and then through an oil/gas separator to produce a clean syngas.

16. The method of claim 14, wherein the electricity generation is performed by a combination of solar panels and fuel cells.

17. The method of claim 16, further comprising storing excess electricity from the electricity generation step in one or more batteries.

18. The method of claim 14, wherein the fixed temperature for pyrolyzing is at least 1000° C.

19. The method of claim 14, further comprising injecting carbon dioxide into the biochar prior to packaging the biochar for storage.

20. The method of claim 14, further comprising injecting superheated steam into the reaction chamber during the pyrolyzing step.
